(19) United States
(12) Patent Application Publication
(10) Pub. No.: US 2015/0298666 A1
(43) Pub. Date: Oct. 22, 2015

(54) Engine Assisted Brake Control on Wheel Slip

(71) Applicant: Caterpillar Inc., Peoria, IL (US)

(72) Inventors: Yun Liu, Peoria, IL (US); Gerry McCann, Dunlap, IL (US); Stefan Wulf, Washington, IL (US); Ry Whittington, Morton, IL (US)

(73) Assignee: Caterpillar Inc., Peoria, IL (US)

(21) Appl. No.: 14/258,585

(22) Filed: Apr. 22, 2014

(51) Int. Cl. B60T 8/175; B60T 8/58; B60T 8/24; B60T 8/32

(52) U.S. Cl. CPC B60T 8/175; B60T 8/3205; B60T 8/58; B60T 8/245

(57) ABSTRACT

Wheel slippage of a machine may be controlled using brake control and engine torque control. In some examples, the present disclosure describes a method of controlling a wheel. Example methods may include sensing a rotational speed of the wheel, and sensing an acceleration of the machine. The method may also include estimating a target speed of the wheel based at least in part on the rotational speed of the wheel and the acceleration of the machine. The method may continue with calculating a speed error, the speed error being a difference between the rotational speed and the target speed. The method may also include controlling a brake of the wheel based on the speed error and/or a torque of an engine of the machine based on the speed error.

### TECHNICAL FIELD

This patent disclosure relates generally to controlling, via brake control and engine control, wheel slippage of a machine based on wheel speed and machine states.

### BACKGROUND

Wheel slippage occurs during operation of many machines, including off-highway vehicles. Such wheel slippage occurs due to various factors, including wheel type, surface type, and environmental conditions. Conventional methods of limiting wheel slip (or traction control) such as brake control for off-highway vehicles are available, but insufficient.

In other solutions, such as in U.S. Pat. No. 7,856,303, titled “Method of determining wheel slippage and engaging a differential lock in a work vehicle,” a differential lock is required to reduce wheel slippage. In these situations, the differential is automatically locked when a wheel slippage condition is sensed. This option is not necessarily ideal, however.

For example, a differential lock requires additional equipment be added to the machine, causing unnecessary costs, increased weight, and mechanical wear and tear. This leads to poor fuel economy and unreliability of the machine.

Accordingly, there is a need for improved methods and systems for controlling wheel slip on off-highway vehicles.

### SUMMARY

In some examples, the present disclosure describes a method of controlling a wheel, including sensing a rotational speed of the wheel, sensing an acceleration of the machine, calculating a target speed of the wheel based at least in part on the rotational speed of the wheel and the acceleration of the machine. The method may also include calculating a speed error, the speed error being a difference between the rotational speed and the target speed, and controlling a brake of the wheel based on the speed error and/or a torque of an engine of the machine based on the speed error.

In some examples, the present disclosure describes a system for controlling a driven wheel of a machine, the system including a speed sensor, a brake, an engine, and an inertial measurement unit, a processing module, and a controller. The speed sensor may sense the rotational speed of the wheel. The brake may reduce the rotational speed of the wheel. The engine may provide torque to the wheel. The inertial measurement unit may measure acceleration. The processing module may estimate a pitch angular position of the machine based at least in part on the rotational speed signal and the acceleration signal, calculate a target speed of the wheel based on the rotational speed signal, the acceleration signal, and the pitch angular position signal, and may calculate a difference between the target speed and the rotational speed to yield a speed error. The controller may generate a brake control signal based on the speed error and may generate an engine control signal based on the speed error.

In some examples, the present disclosure describes a system including a first wheel having a first brake for reducing a first rotational speed of the first wheel, and a second wheel having a second brake for reducing a second rotational speed of the second wheel. The system may also include a processing module configured to receive a signal representative of the first rotational speed and a signal representative of the second rotational speed, calculate a target speed for each of the first wheel and the second wheel, and determine a speed error for each of the first wheel and the second wheel. The system may also include a controller configured to independently control the first brake and the second brake based on the speed error, and to control a torque of an engine of the vehicle.

### BRIEF DESCRIPTION OF THE DRAWINGS

FIG. 1 is a schematic representation of an example machine in accordance with at least one embodiment of the present disclosure.

FIG. 2 is a schematic representation of an example control system in accordance with at least one embodiment of the present disclosure.

FIG. 3 is an example method of controlling a wheel of a machine in accordance with at least one embodiment of the present disclosure.

### DETAILED DESCRIPTION

It should be noted that the methods and systems described herein may be adapted to a large variety of machines. The machine may be an off-highway vehicle such as a truck used in operations associated with an industry such as mining, construction, farming, transportation, or any other industry known in the art. For example, the machine may be an off-highway truck or an earth-moving machine, such as a dozer, wheel loader, excavator, dump truck, backhoe, motor grader, material handler, and the like.

Further, it should be noted that the Figures are illustrative only and they are not drawn to scale.

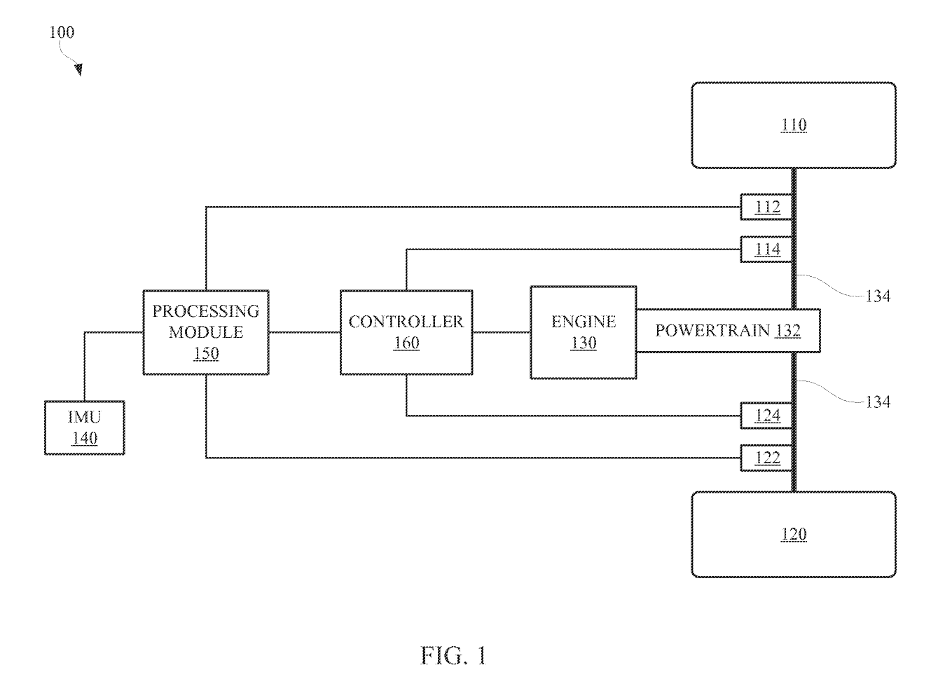

FIG. 1 is a schematic representation of a portion of an example machine 100 in accordance with at least one embodiment of the present disclosure. Some example machines 100 may include a chassis and wheels 110, 120 (or tracks). In some examples, machines 100 may have multiple wheels, such as four or six wheels. For illustrative purposes, FIG. 1 depicts only two wheels 110, 120. Wheels 110, 120 may be driven directly or indirectly by engine 130. Engine 130 may provide torque to the driveline or drivetrain 132 (e.g., drive shafts, differentials, axles 134) of the machine 100, which may cause the wheels 110, 120 to rotate. This rotation may be measured as a rotational speed by speed sensors 112, 122 positioned at or near a respective wheel 110, 120. The speed sensors 112, 122 may output a signal(s) representing the sensed rotational speed of the wheels 110, 120. The rotational speed is affected by the amount of torque produced by engine 130 and/or the amount of torque applied to the wheels 110, 120. The rotational speed may also be restricted or reduced by brake(s) 114, 124 at or near each respective wheel 110, 120.

The example of FIG. 1 also includes an inertial measurement unit (IMU) 140, processing unit 150 and a controller 160. The IMU 140 may be located on the machine and may sense acceleration and rotational rate of the machine 100, among other values. Some example machines 100 may have processing module(s) 150 and controller(s) 160, which may interoperate to control the rotational speed of the wheels 110, 120. The controller 160 may be in communication with the brake(s) 114, 124 to control the brake(s) 114, 124 to limit and/or restrict the rotation of the wheel 110, 120, and may be in communication with the engine 130 to control and/or limit the amount of torque output to the wheels 110, 120.

The IMU 140 may output a signal(s) representing the sensed acceleration and rotational rates of the machine 100, and gravitational forces on the machine. The IMU 140 may include a set of sensors that may measure six degrees of freedom-three linear degrees of freedom (such as acceleration(s) in the directions of the x, y, and z axes in space) and three degrees of freedom for rotational rate (such as pitch, yaw, and roll). The linear degrees of freedom specify an acceleration, and the rotational degrees of freedom specify rotation rates about the x, y, and z axes. Some example IMUs 140 may include three linear accelerometers and three rate gyroscopes. The accelerometers may respond to gravity and/or acceleration (as is known in the art). By combining information in the accelerometer signal(s) with other signals (e.g., wheel speed signals and/or pitch rate signals), it is possible to infer or estimate grade.

Based upon the measurements of acceleration combined with wheel speed and/or rotational rate, a computational unit, such as a circuit or controller, may determine position and grade information of the machine 100. In some examples, the IMU 140 may measure more or less degrees of freedom. For example, an example IMU 140 may measure three linear degrees of freedom and one degree of freedom for rotational rate.

The processing module 150 may be in communication with the IMU 140 and may receive the acceleration. The processing module 150 may also be in communication with the speed sensors 112, 122 and may receive the rotational speed signal(s). The processing module 150 may estimate a pitch angular position of the machine 100 based at least in part on the rotational speed signal(s) and the acceleration signal(s). The processing module 150 may calculate a target speed of each wheel 110, 120 based on the rotational speed signal(s), the acceleration signal(s), and/or the rotational rate signal(s). The processing module 150 may then determine the difference between the target speed and the rotational speed of each wheel 110, 120 to yield a speed error for each wheel 110, 120. In some examples, the processing module 150 may estimate a machine state of the machine 100.

In some examples, the processing module 150 may calculate a target speed based on an estimated “corner” speed or linear ground speed of the machine 100. In some examples, “corner” speed may be a linear speed of a wheel 110, 120 over the ground. In some examples, different algorithms may be used to calculate target speed at relatively higher speeds and relatively lower speeds. For example, when the machine 100 is traveling at relatively higher speeds, the target speed may be calculated as a percentage above the corner speed. When the machine 100 is traveling at relatively lower speeds, the target speed may be calculated as a constant value above the corner speed.

The controller 160 may be in communication with the processing module 150, the brake(s) 114, 124, and/or the engine 130. The controller 160 may control the brake(s) 114, 124 based on the speed error and/or the machine state determined by the processing module 150. Similarly, the controller 160 may control the engine 130 to adjust torque based on the speed error and/or the machine state determined by the processing module 150. The controller 160 may generate and transmit brake control signal(s) and/or engine control signal(s) to control the brake(s) 114, 124 and engine 130, respectively. In some examples, any known type of controller may be used. In some examples, controller 160 may include proportional-integral-derivative (PID) controller(s). For example, the machine of FIG. 1 may include a single PID controller to generate brake control signals for the wheels 110, 120 and to generate engine control signals for the engine 130. In some examples, the machine may have multiple PID controllers—one or more for each brake 114, 124 and one or more for the engine 130.

Periodically, the rotational speed of the wheels 110, 120 and the acceleration and/or angular rotation rate of the machine 100 may be sensed and processed by the processing module 150 so operation of the brake(s) and/or engine may be updated via the controller 160. In some examples, these values may be sensed many times per second such that the machine 100 has precise control of the wheels 110, 120. This may allow the wheels 110, 120 to more effectively engage the ground regardless of the state of the ground on which the machine 100 is operating.

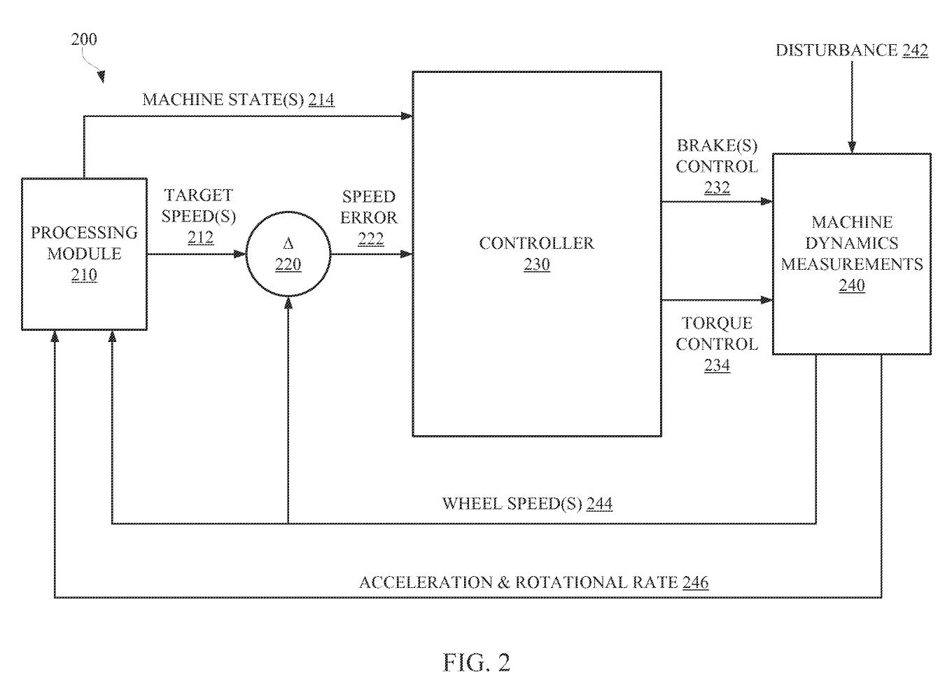

FIG. 2 is a schematic representation of an example control system 200 in accordance with at least one embodiment of the present disclosure. The control system 200 may operate to limit and/or reduce slippage of a wheel during operation of a machine on which the control system 200 operates. The control system 200 may include a processing module 210, a comparator 220, a controller 230, and a machine dynamics measurements module 240.

In use, the machine has certain measurable dynamics, including wheel speed of its wheels, acceleration of the machine, and/or rotational rates of the machine, among others. During operation, disturbances 242 (e.g., steering, rolling resistance) may affect these measurable dynamics. Sensors on the machine may measure certain dynamics and may output signals representative of these measured or sensed dynamics. Some example signals may represent wheel speed 244 and acceleration and rotational rotation rate 246. The control system 200 may use these signals as input into the control system 200.

The processing module 210 may receive the wheel speed 244 signal and acceleration and rotational rate 246 signal and may use these signals to determine and/or calculate a target speed 212 for each wheel of the machine. The processing module 210 may estimate a pitch angular position of the machine based at least in part on these signals. The processing module 210 may also use these signals to determine and/or calculate machine states 214 of the machine. Some example machine states 214 may include pitch angle (e.g., pitch angular position, slope) of the machine, yaw rate of the machine, roll rate of the machine, pitch rate of the machine, the longitudinal velocity of the machine, and the longitudinal acceleration of the machine.

In some examples, processing module 210 may receive and process signals representing many different measurements of the machine, including rotational speed of driven wheel(s), rotational speed of non-driven wheel(s), rotational speed of driveline or drivetrain, gyroscope Z axis (yaw rate), gyroscope X axis (roll rate), gyroscope Y axis (pitch rate), accelerometer X axis, accelerometer Y axis, and accelerometer Z axis, among others. The processing module 210 may process these signals, condition these signals, and align and constrain the signals.

The processing module 210 may condition the received signals. For example, the processing module 210 may use low pass filters to remove high frequency noise in the signals. The wheel speeds and the driveline output speed, for example, may be coupled and cross referenced to detect inconsistent values, obvious errors, and/or sensor failures. For example, a net sum of acceleration in x, y and z axes may be expected to be close to 1 g after machine motion is subtracted. A net sum that deviates substantially from 1 g may indicate an error in the system. A large deviation between wheel speeds may indicate a rough estimate of slip between different speeds. Further, wheel speeds, accelerations, and gyroscope rates may all be constrained together during rolling without slipping, which can be used as a cross reference.

The comparator 220, which may be integrated in the processing module 210, may use the target speeds 212 to determine the difference between the target speeds 212 and the sensed wheel speeds 244 for each wheel. This difference may be the speed error 222 for each of the wheels. Each of the wheels may be operating independently such that each wheel may have a unique wheel speed depending on many factors, including the ground material on which each wheel engages. Therefore, each wheel may also have a unique speed error 222.

The controller 230 may receive signal(s) representing speed errors 222 and the machine states 214, and may control the brakes and/or engine torque based on these signals. The controller 230 may generate brake control signal(s) 232 and/or torque control signal(s) 234 to control the brake(s) and/or engine, respectively.

The controller 230 may include proportional-integral-derivative (PID) controller(s). Some example PID controllers may receive inputs and process those inputs to generate outputs. In some examples, the inputs may include the speed error 222 and the machine states 214. In some examples, the outputs may be the brake control signal 232 and the torque control signal 234.

In some examples, the controller 230 may coordinate the brake control signals 232 and the torque control signals 234 to effectuate wheel slippage reduction. The controller 230 may include a PID controller for each brake to reduce the wheel speed to a target value. In some examples, the controller 230 may include a PID controller for the engine torque. In some examples, the PID controller for the engine torque may be complementary to the brake control. For each brake controller and engine torque controller, a target speed may be calculated. Priorities may be adjusted between brake control and engine control by setting different targets. In some examples, the brake may apply first if the brake control target is tighter than the engine torque control target.

In some examples, engine torque control may be a priority on flat surface and less of a priority on a sloped surface. Such prioritization may be set by adjusting the brake control with a slope estimate. By adding a low pass filter phase lag to the brake control, the engine torque control may have a chance to apply first. In some examples, brake and engine torque control may also be adjusted by the number of wheels that are slipping. Engine torque control may be more aggressive if more than one wheel is slipping. Other machine states may affect engine torque control and brake control coordination. For example, machine velocity or acceleration may be used to adjust the priorities between the engine torque control and the brake control.

The brake control signal(s) 232 and/or torque control signal(s) 234 may be transmitted to the brake(s) and engine to adjust the operation of these components in an effort to reduce or minimize the speed error 222. The control system 200 may periodically loop through this process and may control and/or adjust the brake(s) and/or engine during each loop. In this manner, the control system 200 may effectively address the wheel speed of each wheel in an effort to reduce wheel slippage due to various factors, such as disturbances 242 and surface type. In some examples, the control system 200 may loop through this process many times per second such that precise control of the wheels may be effectuated. This may allow the wheels to more effectively engage the ground regardless of the state of the ground on which the machine is operating.

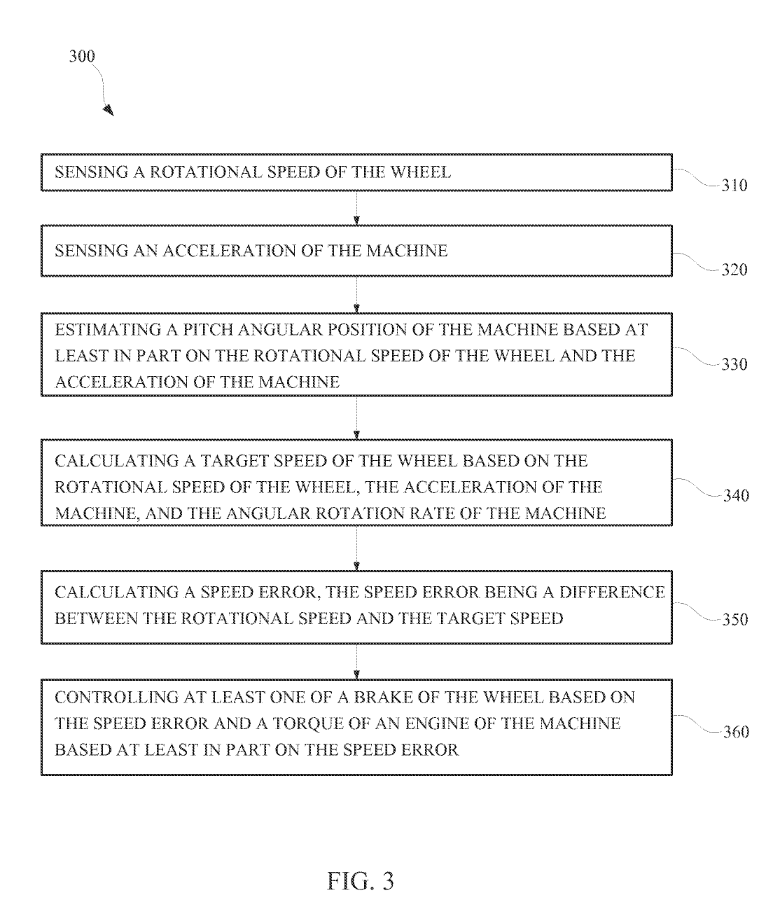

FIG. 3 is an example method 300 of controlling a wheel of a machine in accordance with at least one embodiment of the present disclosure. The method 300 may include sensing 310 a rotational speed of the wheel, and sensing 320 an acceleration of the machine and/or a rotational rate of the machine. The method 300 may also include estimating 330 a pitch angular position of the machine based at least in part on the rotational speed of the wheel and the acceleration of the machine. The method 300 may also include calculating 340 a target speed of the wheel based on the rotational speed of the wheel, the acceleration of the machine, and the pitch angular position of the machine. The method 300 may continue with calculating 350 a speed error, the speed error being a difference between the rotational speed and the target speed. The method 300 may also include controlling 360 a brake of the wheel based on the speed error and/or a torque of an engine of the machine based on the speed error.

In some examples, the method 300 may also include estimating a machine state of the machine based on the rotational speed, the acceleration, and the rotational rate. In such examples, controlling the brake of the wheel may be based on the speed error and the machine state, and controlling the torque of the engine of the machine may be based on the speed error and the machine state.

### INDUSTRIAL APPLICABILITY

The present disclosure is applicable to a variety of machines in general (e.g., off-highway trucks, track-type tractors, skid steer loaders). Such machines may operate in many environments and may engage many types of surfaces. Some of these surfaces may be relatively unstable and may be tend to provide little traction for wheels or tracks engaging the surface. This may cause one or more wheels of the machine to slip or lose contact with the surface during operation. It may be helpful for machines to reduce such wheel slippage to maintain better and more contact with the surface. Wheel slippages are common when machines are used for construction, farming, and other tasks in difficult terrain.

Some examples may be useful for haul trucks used in the mining industry. Usually, as in an open pit operation, ore is hauled from the bottom of the mine along a spiral road up to the top. In some cases, the haul may be downhill, for example, from the top of a mountain. Regardless the trucks have to run uphill in an empty or a loaded condition.

Normally, the haul roads are reasonably well maintained. However, mines may be in areas subject to occasional or seasonal heavy rainstorms. In many cases operations cease during the rainstorms with a negative impact on mine economics. It may be necessary to repair the roads after the rainstorms before safe truck operation can resume. Some examples of the present disclosure may allow the trucks to resume operation before the roads are completely repaired. In some examples, it may allow continued operation during the storm. For example, storm runoff may form a small rivulet at the side of the road but may leave much of the road surface intact. Some example systems may mitigate wheel spin in the rivulet and allow continued operation.

Likewise for mines in arctic areas it may be difficult to keep the haul road clear of ice and snow. Rivulets of ice or snow may form in patches on the road. Some example systems help to keep trucks operational in these conditions. For example, there may be a flat portion of the haul where the surface is largely covered by snow and ice. In this example, the operation of the wheel slip control system may keep wheel spin in check. This helps truck stability and also reduces the chances of tire damage. A spinning tire may get sliced on a rock protruding from the ice.

Reducing wheel speed may help truck stability and make the truck easier to control. Also, depending on the operating conditions it may significantly help tire life. With an open differential, torque is equalized side to side. But if one tire is on ice, for example, then there is very little resistive torque on that wheel from the ground. So, by the action of the differential, then there is also very little torque on the wheel on the other side of the axle (and that wheel may be on a good surface). So, even though ground conditions would allow movement, the truck will get stuck, fundamentally because little torque is available to rotate the wheel that is on the good surface. The wheel on ice will spin. The wheel on the good surface will remain stationary and the truck will not move. By applying brake torque to check the wheel spin on ice, in effect, this brake torque gets transferred by the differential to the wheel on the good surface where it becomes a propelling torque for the wheel. The truck is now mobile.

In some examples, a system for controlling a wheel may be provided. Example systems may include a computing device operatively enabled to perform the method(s) herein to control a wheel. Some example computing devices may interact with other systems and/or components to perform the method(s) herein to control a wheel. In some examples, computing devices may include electronic control modules (ECMs).

In some examples, an example non-transitory storage medium may include machine-readable instructions stored thereon which, when executed by processing unit(s) of a computing device, operatively enable the computing device to control a wheel.

Example computing devices may be of any suitable construction, however in one example it may include a digital processor system including a microprocessor circuit having data inputs and control outputs, operating in accordance with computer-readable instructions stored on a computer-readable medium. In some examples, the processor may have associated therewith long-term (non-volatile) memory for storing the program instructions, as well as short-term (volatile) memory for storing operands and results during (or resulting from) processing. Further, computing device may read computer-executable instructions from a computer-readable medium and executes those instructions. Example media readable by a computer may include both tangible and intangible media. Examples of the former include magnetic discs, optical discs, flash memory, RAM, ROM, tapes, cards, and the like. Examples of the latter include acoustic signals, electrical signals. AM and FM waves, and the like.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

All methods described herein may be performed in any suitable order unless otherwise indicated herein or otherwise clearly contradicted by context.

We claim:

1. A method of controlling a wheel of a machine, the method comprising:
sensing a rotational speed of the wheel;
sensing an acceleration of the machine;
estimating a pitch angular position of the machine based at least in part on the rotational speed of the wheel and the acceleration of the machine;
calculating a target speed of the wheel based on at least two of the rotational speed of the wheel, the acceleration of the machine, and the pitch angular position of the machine;
calculating a speed error, the speed error being a difference between the rotational speed and the target speed; and
controlling at least one of a brake of the wheel based on the speed error and a torque of an engine of the machine based at least in part on the speed error.

2. The method of claim 1, where controlling at least one of the brake of the wheel based on speed error and the torque of the engine of the machine based at least in part on the speed error comprises at least one of:
adjusting the brake to reduce the speed error, and
adjusting the torque of the engine to reduce the speed error.

3. The method of claim 1, further comprising:
estimating a machine state of the machine based on at least two of the rotational speed, the acceleration, and the pitch angular position;
wherein controlling the brake of the wheel is based at least in part on the speed error and the machine state; and
wherein controlling the torque of the engine of the machine is based at least in part on the speed error and the machine state.

4. The method of claim 3, wherein the machine state comprises at least one of a pitch angle of the machine, a longitudinal velocity of the machine, and a longitudinal acceleration of the machine, a yaw rate of the machine, a pitch rate of the machine, and a roll rate of the machine.

5. The method of claim 1,
wherein controlling the brake of the wheel based at least in part on the speed error is based on minimizing the speed error; and
wherein controlling the torque of the engine of the machine based at least in part on the speed error is based on minimizing the speed error.

6. The method of claim 1, further comprising:
after at least one of adjusting the brake and adjusting the torque,
sensing the rotational speed of the wheel to generate an updated rotational speed of the wheel;
sensing the acceleration of the machine to generate an updated acceleration;
estimating the pitch angular position of the machine based at least in part on the updated rotational speed of the wheel and the updated acceleration of the machine to generate an updated pitch angular position;
calculating an updated target speed of the wheel based on at least two of the updated rotational speed, the updated acceleration, and the updated pitch angular position;
calculating an updated speed error, the updated speed error being a difference between the updated rotational speed and the updated target speed; and
controlling at least one of the brake of the wheel based on the updated speed error and the torque of an engine of the machine based at least in part on the updated speed error.

7. The method of claim 1, wherein at least one of adjusting the brake of the wheel based at least in part on the speed error and adjusting the torque of an engine of the machine based at least in part on the speed error.

8. The method of claim 1, wherein estimating the target speed of the wheel is based on the rotational speed of the wheel, the acceleration of the machine, and the pitch angular position of the machine.

9. A system for controlling a driven wheel of a machine, the system comprising:
a speed sensor configured to sense a rotational speed of the driven wheel, the speed sensor generating a speed signal representative of the rotational speed;
a brake configured to reduce the rotational speed of the driven wheel;
an engine configured to provide torque to the driven wheel;
an inertial measurement unit configured to determine an acceleration of the machine, the inertial measurement unit generating an acceleration signal representative of the acceleration; and
a processing module in electrical communication with the speed sensor and the inertial measurement unit, the processing module configured to:
estimate a pitch angular position of the machine based at least in part on the rotational speed signal and the acceleration signal;
calculate a target speed of the wheel based on the rotational speed signal, the acceleration signal, and the pitch angular position; and
calculate a difference between the target speed and the rotational speed to yield a speed error,
a controller in electrical communication with the processing module, the brake, and the engine, the controller configured to:
generating a brake control signal based on the speed error, the brake control signal representative of a brake adjustment for the brake; and
generating a torque control signal based on the speed error, the torque control signal representative of a torque adjustment for the engine.

10. The system of claim 9, wherein the processing module is further configured to estimate a machine state of the machine based on the rotational speed signal, the acceleration signal, and the rotational rate signal.

11. The system of claim 10,
wherein generating the brake control signal is based on the speed error and the machine state; and
wherein generating the torque control signal is based on the speed error and the machine state.

12. The system of claim 9,
wherein the driven wheel comprises a plurality of driven wheels; and
wherein the controller is configured to calculate the difference between the target speed and the rotational speed to yield the speed error for each driven wheel of the plurality of driven wheels.

13. The system of claim 9, wherein the inertial measurement unit is configured to measure from one to three axes of acceleration and from one to three axes of rotational rate.

14. The system of claim 9, further comprising:
a brake controller in electrical communication with the brake and the controller, the brake controller configured to adjust the brake based at least in part on the brake control signal; and
an engine controller in electrical communication with the engine and the controller, the engine controller configured to adjust the torque of the engine based at least in part on the torque control signal.

15. A system for controlling a plurality of wheels of a vehicle, comprising:
a first wheel having a first brake for reducing a first rotational speed of the first wheel;
a second wheel having a second brake for reducing a second rotational speed of the second wheel;
a processing module configured to receive a signal representative of the first rotational speed and a signal representative of the second rotational speed, calculate a target speed for each of the first wheel and the second wheel, and determine a speed error for each of the first wheel and the second wheel; and
a controller configured to independently control the first brake and the second brake based on the speed error, and to control a torque of an engine of the vehicle.

16. The system of claim 15, further comprising:
a first speed sensor configured to sense the first rotational speed; and
a second speed sensor configured to sense the second rotational speed.

17. The system of claim 15, further comprising:
an inertial measurement unit configured to measure at least one machine state of the vehicle;
wherein the processing module calculates the target speed for each of the first wheel and the second wheel based at least in part on the first rotational speed, the second rotational speed, and the at least one machine state.

18. The system of claim 15, wherein the controller is configured to control the first brake and the second brake by actuating at least one of the first brake and the second brake.

19. The system of claim 15, wherein the controller is configured to control the torque of the engine of the vehicle by limiting the torque of the engine.

20. The system of claim 15,
wherein the controller includes at least one proportional-integral-derivative controller to control the first brake, the second brake, and the torque of the engine of the vehicle.
